(19) United States
(12) Patent Application Publication
(10) Pub. No.: US 2017/0183471 A1
(43) Pub. Date: Jun. 29, 2017

(54) METHOD FOR PRODUCING EXTRUDED POLYSTYRENE FOAM

(71) Applicant: KANEKA CORPORATION, Osaka-shi (JP)

(72) Inventors: Takenori KIKUCHI, Settsu-shi (JP); Wataru KADO, Settsu-shi (JP); Koji SHIMIZU, Settsu-shi (JP)

(73) Assignee: KANEKA CORPORATION, Osaka-shi (JP)

(21) Appl. No.: 15/308,615

(22) PCT Filed: Apr. 23, 2015
(86) PCT No.: PCT/JP2015/062424

§ 371 Date: Nov. 3, 2016

(30) Foreign Application Priority Data
May 9, 2014 (JP) 2014-097882

(51) Int. Cl. C08J 9/14; B29C 44/20; B29C 47/00; C08J 9/00

(52) U.S. Cl. CPC C08J 9/146; C08J 9/149; C08J 9/145; C08J 9/142; C08J 9/0023; C08J 9/0066; C08J 9/0038; B29C 44/20; B29C 47/0004; B29C 47/0021; C08J 2203/162; C08J 2205/052; C08J 2325/06; C08J 2203/182; C08J 2203/142; C08J 2203/12; C08J 2201/03; B29K 2025/06

(57) ABSTRACT

A method for producing an extruded polystyrene foam in which when a foamable melted product, obtained by heat-melting a styrene resin composition and adding a foaming agent thereto in an extruder provided with a die slit section having an opening a (mm) in the thickness direction, is extrusion-foamed through the die slit section into a low pressure zone to form a plate-shaped foam, thereby obtaining an extruded polystyrene foam having a density of 20 kg/m³ or more and 45 kg/m³ or less, a closed cell ratio of 90% or more, and a thickness A (mm) of 10 mm or more and 150 mm or less, a foaming agent containing hydrofluoroolefin and other organic foaming agent is used, a thickness extension ratio A/a of an opening a in the thickness direction of the die slit section and a thickness A of the extruded polystyrene foam is adjusted to 18 or less, and a foamable melted product, just before the extrusion from the die slit section, is pressurized to 4.5 MPa or more and 10.0 MPa or less.

### TECHNICAL FIELD

The present invention relates to a method for producing an extruded polystyrene foam.

### BACKGROUND ART

Extruded polystyrene foams are, in general, continuously produced by melting a styrene resin or styrene resin composition with heat using an extruder or the like, adding a foaming agent thereto under high pressure conditions to form a foamable melted product, cooling it to a pre-determined temperature, and extruding it into a pressure area lower than that of an inside of the extruder.

The extruded polystyrene foam is used, for example, as a heat-insulating material of a structure, because of its good workability and heat-insulating property. Recently, the request for saving energy in houses, buildings, and the like has been increased, and it is desirable to develop foams having a heat-insulating property higher than those of conventional products.

Conventionally, a chlorofluorohydrocarbon (hereinafter referred to as “CFC”) such as dichlorodifluoromethane has been widely used as a physical foaming agent used in the production of an extruded polystyrene foam. However, CFC has a large risk to deplete the ozone layer, and accordingly a hydrogen atom-containing chlorofluorohydrocarbon (hereinafter referred to as “HCFC”) having a small ozone depleting potential has been used instead of CFC. However, HCFC does not have an ozone depleting potential of 0 (zero), and the risk to deplete the ozone layer does not completely disappear. In recent years, accordingly, a fluorohydrocarbon (hereinafter referred to as “HFC”) having an ozone depleting potential of 0 (zero) and containing no chlorine atom in the molecule has been used as the foaming agent.

For example, Patent Document 1 discloses as a method for producing a styrene resin foam having excellent heat-insulating property for a long period of time and capable of being suitably used as a heat-insulating material for houses using HFC having an ozone depleting potential of 0 as a foaming agent, a method for producing a foam having a density of 2×10⁻² to 4.5×10⁻² g/cm³ which contains the step of injecting a foaming agent which is a mixture of trifluoroethane, which is one kind of HFCs, and methyl chloride into a styrene resin thereby to perform extrusion-foaming. The method, however, has a defect in which HFC has a large global warming potential.

Methods for producing a thermal insulation board of an extruded polystyrene foam are proposed which use a fluorinated olefin (hydrofluoroolefin, which may sometimes be referred to as “HFO”) having an ozone depleting potential of 0 (zero), a small global warming potential, and just a few effects on the environment, as an alternative foaming agent of HFC (see, for example, Patent Documents 2 to 5). According to the conventional techniques described above, however, an extruded polystyrene foam having excellent heat-insulating property and flame retardance cannot be obtained by sufficiently exhibiting merits (a low thermal conductivity and a hard combustibility) which are obtained by using HFO, and the techniques have yet problems to be solved.

In addition, HFO has a solubility in the styrene resin lower than those of foaming agents, which have been conventionally used, and thus the obtained extruded polystyrene foam has spots (pores) or waves on the surface thereof, thereby causing a problem of an impaired appearance.

### PRIOR ART TECHNICAL DOCUMENTS

### Patent Document

Patent Document 1: JP-A No. H08-269224

Patent Document 2: JP-A No. 2012-007094

Patent Document 3: JP-T No. 2008-546892

Patent Document 4: JP-A No. 2013-194101

Patent Document 5: JP-T No. 2010-522808

### SUMMARY OF INVENTION

### Technical Problem

The present invention aims at providing a method for producing an extruded polystyrene foam, which is lightweight, has excellent heat-insulating property and flame retardance, and has improved appearance, using a foaming agent containing HFO whose ozone depleting potential is very small, whose global warming potential is considerably small, and which affects the environment only a little.

### Solution to Problem

As a result of painstaking studies for solving the problems described above, the present inventors have found that, in extrusion-foaming using a foaming agent containing HFO having an ozone depleting potential of zero and a small global warming potential, when a ratio of an opening a (mm) in thickness direction of a die slit section of an extruder used to a thickness A (mm) of an extruded polystyrene foam obtained by the extrusion-foaming, i.e., a thickness extension ratio A/a, is adjusted to a pre-determined range, and, just before the extrusion of a foamable melted product obtained by adding the foaming agent to a melted product of a resin composition containing a styrene resin, a foaming pressure applied to the foamable melted product is adjusted to a pre-determined range, then an extruded polystyrene foam is obtained which is lightweight, has excellent heat-insulating property and flame retardance, and has excellent appearance without spots or waves on the surface thereof; and have completed the present invention.

The present invention, accordingly, relates to the following methods (1) to (13) for producing an extruded polystyrene foam.
(1) A method for producing an extruded polystyrene foam having a density of 20 kg/m³ or more and 45 kg/m³ or less, a closed cell ratio of 90% or more, and a thickness A (mm)of 10 mm or more and 150 mm or less, which contains extrusion-foaming, in an extruder provided a die slit section with an opening a (mm) in a thickness direction, a foamable melted product, obtained by heat-melting a resin composition containing a styrene resin and adding a foaming agent thereto, through the die slit section into a low pressure zone to form a plate-shaped foam, wherein the foaming agent contains hydrofluoroolefin and other organic foaming agent, a thickness extension ratio A/a of an opening a in thickness direction of the die slit section and a thickness A of the extruded polystyrene foam is adjusted to 18 or less, and a foamable melted product, just before the extrusion from the die slit section, is pressurized to 4.5 MPa or more and 10.0 MPa or less.
(2) The method for producing an extruded polystyrene foam according to (1) above, wherein the thickness extension ratio A/a is within a range of 3 or more and 18 or less.
(3) The method for producing an extruded polystyrene foam according to (1) or (2) above, wherein the opening a in thickness direction of the die slit section is within a range of 1.0 mm or more and 15.0 mm or less.
(4) The method for producing an extruded polystyrene foam according to any of (1) to (3) above, wherein the hydrofluoroolefin is added in an amount of 0.030 mol or more and 0.125 mol or less, relative to 100 g of the styrene resin.
(5) The method for producing an extruded polystyrene foam according to any of (1) to (4) above, wherein the hydrofluoroolefin is added in an amount of 0.040 mol or more and 0.105 mol or less, relative to 100 g of the styrene resin.
(6) The method for producing an extruded polystyrene foam according to any of (1) to (5) above, wherein the hydrofluoroolefin is tetrafluoropropene.
(7) The method for producing an extruded polystyrene foam according to any of (1) to (6) above, wherein the other organic foaming agent contains an organic foaming agent having a polystyrene permeability of 0.5×10⁻¹⁰ cc·cm/cm²·s·cm Hg or more and does not contain an organic foaming agent having a polystyrene permeability of less than 0.5×10⁻¹⁰ cc·cm/cm²·s·cm Hg.
(8) The method for producing an extruded polystyrene foam according to (7) above, wherein the organic foaming agent having a polystyrene permeability 0.5×10⁻¹⁰ cc·cm/cm²·s·cm Hg or more is one or more compounds selected from dimethyl ether, methyl chloride, and ethyl chloride.
(9) The method for producing an extruded polystyrene foam according to any of (1) to (8) above, wherein the hydrofluoroolefin and the other organic foaming agent are contained in a total amount of 0.105 mol or more and 0.300 mol or less, relative to 100 g of the styrene resin.
(10) The method for producing an extruded polystyrene foam according to any of (1) to (9) above, wherein the resin composition is a resin composition containing a flame retardant in an amount of 0.5 parts by weight or more and 8.0 parts by weight or less, relative to 100 parts by weight of the styrene resin.
(11) The method for producing an extruded polystyrene foam according to (10) above, wherein the flame retardant is a bromine-containing flame retardant, and the bromine-containing flame retardant is contained in an amount of 0.5 parts by weight or more and 6.0 parts by weight or less, relative to 100 parts by weight of the styrene resin.
(12) The method for producing an extruded polystyrene foam according to any of (1) to (11) above, wherein the resin composition further contains a heat ray radiation inhibitor.
(13) The method for producing an extruded polystyrene foam according to (12) above, wherein the heat ray radiation inhibitor is one or more compound selected from the group consisting of graphite, titanium oxide, and barium sulfate.

### Advantageous Effects of Invention

According to the present invention, an extruded polystyrene foam can be easily obtained which is lightweight, has excellent heat-insulating property and flame retardance, and has improved appearance.

### DESCRIPTION OF EMBODIMENTS

Embodiments of the present invention are explained below. Please note that the embodiments are only a part of the present invention, and it is needless to say that the embodiments may be suitably modified within a range in which the gist of the present invention is not changed.

The method for producing an extruded polystyrene foam of the present invention is a method in which extrusion-foaming of a resin composition containing a styrene resin, which is a starting material, is performed using a foaming agent containing a hydrofluoroolefin whose ozone depleting potential is very small and whose global warming potential is considerably small and other organic foaming agent.

The production method of the present invention is performed, for example, in a manner in which a resin composition containing a styrene resin (hereinafter referred to as a “styrene resin composition”) is supplied to an extruder, the composition is heat-melted, a foaming agent containing a hydrofluoroolefin and other organic foaming agent is added thereto to form a foamable melted product, and the resulting foamable melted product is extruded through a the slit section (mouthpiece), provided on the extruder, to a zone having a lower pressure than that of the inside of the extruder to foam it, whereby the foam is formed.

In order to obtain the extruded polystyrene foam having pre-determined properties, the present invention is characterized in that, when a thickness of the foam is defined as A (mm) and an opening in thickness direction at an outlet of the die slit section (mouthpiece) provided on the extruder is defined as a (mm), a ratio of the A and the a, i.e., a thickness extension ratio A/a; and a foaming pressure applied to the foamable melted product just before the extrusion-foaming of the foamable melted product from the die slit section (hereinafter referred to as a “foaming pressure” unless otherwise noted) are specified to pre-determined ranges.

The thickness extension ratio A/a is 18 or less, and in terms of the stable mass-production of the extruded polystyrene foam having the desired properties, it is preferably 3 or more and 18 or less, more preferably 4 or more and 15 or less, still more preferably 5 or more and 10 or less. When the thickness extension ratio A/a is more than 18, the obtained extruded polystyrene foam may have waves on the surface thereof and impaired surface smoothness, and the use thereof as a heat-insulating material or a cushioning material may possibly be restricted. When the thickness extension ratio A/a is less than 3, it tends to easily form spots on the surface of the obtained extruded polystyrene foam, and the appearance thereof may be impaired to some extent.

The foaming pressure is 4.5 MPa or more and 10.0 MPa or less, and in terms of the stable mass-production of the extruded polystyrene foam having the desired properties, it is preferably 4.5 MPa or more and 8.0 MPa or less. When the foaming pressure is less than 4.5 MPa, a large number of spots are generated on the surface of the extruded polystyrene foam, thus resulting in the poor appearance, or molding failure may possibly occur in some cases. When the foaming pressure is more than 10.0 MPa, waves are generated on the surface of the extruded polystyrene foam and the appearance thereof is deteriorated, and excess work such as cutting work of the surface for using the foam as a heat-insulating material may possibly become necessary.

In the production method of the present invention, the thickness extension ratio A/a is 18 or less, and the foaming pressure is 4.5 MPa or more and 10.0 MPa or less, but the range of the thickness extension ratio A/a, 18 or less, may be changed to 3 or more and 18 or less, 4 or more and 15 or less, or 5 or more and 10 or less and/or the range of foaming pressure, 4.5 MPa or more and 10.0 MPa or less, may be changed to 4.5 MPa or more and 8.0 MPa or less.

The extruded polystyrene foam, obtained by the production method of the present invention, is plate-shaped, having a thickness of 10 mm or more and 150 mm or less, and is lightweight and highly heat-insulating, having a density of 20 kg/m³ or more and 45 kg/m³ or less, and a closed cell ratio of 90% or more. The foam has the excellent flame retardance and has the excellent appearance without spots or waves on the surface, and thus it is useful, for example, as a heat-insulating material or a cushioning material for various structures such as houses and buildings and various pieces of furniture.

With respect to the production method of the present invention, the styrene resin composition, which is used as the starting material, the foaming agent, and the extrusion-foaming method are explained in more detail this order below.

### [Styrene Resin Composition]

The styrene resin, contained in the styrene resin composition, is not particularly limited, and may include, for example, at least one polymer selected from the group consisting of homopolymers (x) of a styrene monomer, copolymers (y) of two or more kinds of styrene monomers, copolymers (z) of a styrene monomer and a monomer other than the styrene monomer copolymerizable therewith (hereinafter referred simply to as “other monomer”). The styrene monomer may include, for example, styrene compounds such as styrene, methyl styrene, ethyl styrene, isopropyl styrene, dimethyl styrene, bromostyrene, chlorostyrene, vinyl toluene, and vinyl xylene. They may be used alone or as a mixture of two or more kinds. The other monomer may include, for example, divinyl benzene, butadiene, acrylic acid, methacrylic acid, methyl acrylate, methyl methacrylate, acrylonitrile, maleic acid anhydride, itaconic acid anhydride, and the like. They may be used alone or as a mixture of two or more kinds. The other monomers, in particular, acrylic acid, methacrylic acid, methyl acrylate, methyl methacrylate, maleic acid anhydride, and itaconic acid anhydride may be used in an amount that the physical properties such as compression strength of the extruded polystyrene foam produced are not deteriorated. The styrene resin, used in the present invention, is not limited to the homopolymer (x), the copolymer (y), and the copolymer (z), and it may be a blend of at least one polymer selected from the homopolymer (x), the copolymer (y), and the copolymer (z) containing the styrene monomer with the homopolymer and/or the copolymer containing the other monomer, and a blend with a rubber-reinforced diene-based polystyrene or a rubber-reinforced acrylic polystyrene. Further, the styrene resin, used in the present invention, may be a styrene resin having a branched structure, for the purpose of controlling a melt flow rate (hereinafter referred to as “MFR”), and a melt viscosity, a melt tension, and the like upon the molding processing.

It is preferable in the present invention to use a styrene resin having an MFR of 0.1 to 50 g/10 minutes as the styrene resin, because the molding processability is excellent upon the extrusion-foaming; it is easy to adjust an discharge amount of the foamable melted product from the die slit section upon molding processing, and a thickness, a width, an apparent density, and a closed cell ratio of the obtained extruded polystyrene foam to desired values; an extruded polystyrene foam having excellent foamability (the better the foam ability, the easier the control of the thickness, the width, the apparent density, the closed cell ratio, and the surface property of the foam to desired values and states) and excellent appearance can be obtained; and an extruded polystyrene foam having well-balanced properties in the mechanical strengths such as the compression strength, bending strength, and the bending deflection volume and the property such as toughness is obtained. The styrene resin has more preferably an MFR of 0.3 to 30 g/10 minutes, particularly preferably 0.5 to 25 g/10 minutes, in terms of the balance in the molding processability, the mechanical strengths to the foamability, the toughness, and the like. In the present invention, MFR is measured according to JIS K 7210 (1999), A method, under test conditions H.

In the present invention, among the styrene resins described above, the homopolymer (x) of the styrene monomer is preferable, and the polystyrene resin is particularly preferable in terms of the economy and proccesability. When it is required for the extruded polystyrene foam to have the higher heat resistance, the copolymer (z) of the styrene monomer and the other monomer is preferable, and the styrene-acrylonitrile copolymer, the polystyrene of (meth)acrylic acid copolymer, the maleic acid anhydride-modified polystyrene are more preferable. When it is required for the extruded polystyrene foam to have the higher impact resistance, it is preferable to use the rubber-reinforced polystyrene. The styrene resins may be used alone or as a mixture of two or more kinds of styrene resins whose copolymerizable component, molecular weight, molecular weight distribution, branched structure, or MFR is different from each other.

The styrene resin composition may contain, as an optional component other than the styrene resin, a flame retardant, flame retardant promoter, a stabilizer of flame retardant, a heat ray radiation inhibitor (hereinafter which may sometimes be referred to as a “radiation inhibitor”), a resin additive, and the like. Among the styrene resin compositions, a styrene resin composition containing the flame retardant is preferable, a styrene resin composition containing the flame retardant and the flame retardant promoter and/or the stabilizer of flame retardant is more preferable, and a styrene resin composition containing the flame retardant, the flame retardant promoter and/or the stabilizer of flame retardant, and the radiation inhibitor is still more preferable.

The flame retardant is not particularly limited, and various flame retardants for a resin can be used. The bromine-containing flame retardant can be preferably used. Specific examples of the bromine-containing flame retardant may include bromine-containing aliphatic polymers such as hexabromocyclododecane, tetrabromobisphenol A-bis(2,3-dibromo-2-methylpropyl)ether, tetrabromobisphenol A-bis(2,3-dibromopropyl)ether, tris(2,3-dibromopropyl)isocyanurate, and brominated styrene-butadiene block-copolymers. Of these, a mixed bromine-containing flame retardant containing the hexabromocyclododecane, tetrabromobisphenol A-bis(2,3-dibromo-2-methylpropyl)ether, and tetrabromobisphenol A-bis(2,3-dibromopropyl)ether, and the brominated styrene-butadiene block-copolymer are desirably used because the extrusion operation is well performed and they do not affect adversely to the heat resistance of the foam. The flame retardants may be used alone or as a mixture of two or more kinds.

The amount of the flame retardant added to the styrene resin composition is not particularly limited For example, when the flame retardant is contained in an amount of 0.5 parts by weight or more and 8.0 parts by weight or less, relative to 100 parts by weight of the styrene resin, the excellent flame retardance can be imparted to the obtained extruded polystyrene foam. When the amount of the flame retardant added is less than 0.5 parts by weight, it tends to be difficult to obtain the good physical properties as the extruded polystyrene foam, such as the flame retardance. On the other hand, when the amount of the flame retardant added is more than 8.0 parts by weight, the stability during the production of the extruded polystyrene foam and the surface property thereof may sometimes be impaired. It is more preferable to suitably adjust the amount of the flame retardant added so that the flame retardance provided on JIS A 9511 measurement method A can be obtained by following the amount of the foaming agent added, the apparent density of the extruded polystyrene foam, the kinds and the amounts of the flame retardant promoter having a flame-resisting synergistic effect and the stabilizer of flame retardant added.

When the bromine-containing flame retardant is used as the flame retardant, the amount of the bromine-containing flame retardant added to the styrene resin composition is preferably 0.5 parts by weight or more and 6.0 parts by weight or less, more preferably 1.0 part by weight or more and 5.0 parts by weight or less, still more preferably 1.5 parts by weight or more and 4.0 parts by weight or less, relative to 100 parts by weight of the styrene resin. When the amount of the bromine-containing flame retardant added is less than 0.5 parts by weight, it tends to be difficult to obtain good physical properties as the extruded polystyrene foam such as flame retardance. On the other hand, when it is more than 6.0 parts by weight, the stability during the production of the extruded polystyrene foam and the surface property thereof may sometimes be impaired.

For example, for the purpose of further improving the flame retardance of an extruded polystyrene foam, the flame retardant promoter can be used together with the flame retardant. The flame retardant promoter may include, for example, a radical generator, a phosphorus flame retardant, and the like.

The radical generator is not particularly limited, and may include, for example, 2,3-dimethyl-2,3-diphenylbutane, poly-1,4-diisopropylbenzene, 2,3-diethyl-2,3-diphenylbutane, 3,4-dimethyl-3,4-diphenylhexane, 3,4-diethyl-3,4-diphenylhexane, 2,4-diphenyl-4-methyl-1-pentene, 2,4-diphenyl-4-ethyl-1-pentene, and the like. Peroxides such as dicumyl peroxide can be used. Of these, a radical generator which is stable in a resin-processing temperature condition is preferable, and specifically 2,3-dimethyl-2,3-diphenylbutane and poly-1,4-diisopropylbenzene are preferable. The radical generator is preferably added to the styrene resin composition in an amount of 0.05 parts by weight or more and 0.5 parts by weight or less, relative to 100 parts by weight of the styrene resin.

The phosphorus flame retardant is used in a range that the thermal stability of the extruded polystyrene foam is not impaired. As the phosphorus flame retardant, a phosphoric acid ester and phosphine oxide are used, and they may be used together. The phosphoric acid ester may include triphenyl phosphate, tricresyl phosphate, trixylenyl phosphate, cresyldiphenyl phosphate, 2-ethylhexyldiphenyl phosphate, trimethyl phosphate, triethyl phosphate, tributyl phosphate, tris(2-ethylhexyl)phosphate, tris(butoxyethyl)phosphate, condensed phosphoric acid ester, and the like, and triphenyl phosphate is particularly preferable. As the phosphine oxide type phosphorus flame retardant, triphenyl phosphine oxide is preferable. The phosphoric acid esters and the phosphine oxides may be each used alone or as a mixture of two or more kinds, and the phosphoric acid ester and the phosphine oxide may be used together. The phosphorus flame retardant is preferably added to the styrene resin composition in an amount of 0.1 parts by weight or more and 2 parts by weight or less, relative to 100 parts by weight of the styrene resin.

The stabilizer of flame retardant, for example, can improve the thermal stability of the extruded polystyrene foam without reducing the flame retardance of the foam. The stabilizer of flame retardant is not particularly limited, and may include, for example, epoxy compounds such as bisphenol A diglycidyl ether type epoxy resins, cresol novolac type epoxy resins, and phenol novolac type epoxy resins; polyhydric alcohol esters such as partial esters of dipentaerythritol and adipic acid (reaction mixture of dipentaerythritol-adipic acid), and reaction product of dipentaerythritol and a polyhydric alcohol; phenol stabilizers such as triethylene glycol-bis-3-(3-tert-butyl-4-hydroxy-5-methylphenyl)propionate, pentaerythritol tetrakis[3-(3′,5′-di-tert-butyl-4′-hydroxyphenyl)propionate], and octadecyl 3-(3,5-di-tert-butyl-4-hydroxyphenyl)propionate; phosphite stabilizers such as 3,9-bis(2,4-di-tert-butylphenoxy)-2,4,8,10-tetraoxa-3,9-diphosphaspiro[5.5]undecane, 3,9-bis(2,6-di-tert-butyl-4-methylphenoxy)-2,4,8,10-tetraoxa-3,9-diphosphaspiro[5.5]undecane, and tetrakis(2,4-di-tert-butyl-5-methylphenyl)-4,4′-biphenylenediphosphonite), and the like. The stabilizers of flame retardant may be used alone or as a mixture of two or more kinds.

The radiation inhibitor refers to a substance having a property capable of reflecting, scattering, or absorbing lights in near infrared and infrared regions (for example, a region of a wavelength of about 800 to about 3000 nm). The extruded polystyrene foam having the further improved heat-insulating property can be obtained by adding the radiation inhibitor. The radiation inhibitor is not particularly limited so long as it has the property described above, and may include, for example, white inorganic particles such as graphite, titanium oxide, barium sulfate, zinc oxide, aluminum oxide, and antimony oxide, and the like. Of these, in terms of the large effect of suppressing heat ray radiation, graphite, titanium oxide, and barium sulfate are preferable, graphite and titanium oxide are more preferable, and graphite is still more preferable. The radiation inhibitors may be used alone or as a mixture of two or more kinds.

The radiation inhibitor is added to the styrene resin composition in an amount of preferably 1.0 part by weight or more and 6.0 parts by weight or less, more preferably 2.0 parts by weight or more and 5.0 parts by weight or less, relative to 100 parts by weight of the styrene resin. When the content of the radiation inhibitor is less than 1.0 part by weight, it tends to be difficult to improve the heat-insulating property. On the other hand, when it is more than 6.0 parts by weight, it tends to deteriorate the extrusion stability or formability, and it tends to impair the combustibility.

The resin additive is used in a range that the effects of the present invention are not inhibited. The resin additive is not particularly limited, and may include, for example, inorganic compounds such as silica, calcium silicate, wallastonite, kaolin, clay, mica, zinc oxide, titanium oxide, and calcium carbonate; processing aids such as sodium stearate, magnesium stearate, barium stearate, liquid paraffin, olefin wax, and a stearylamide compound; phenol anti-oxidizing agents; light-resistant stabilizer such as a phosphorus-containing stabilizer, a nitrogen-containing stabilizer, a sulfur-containing stabilizer, benzotriazol, and hindered amine; flame retardants other than the above; antistatic agents; coloring agents such as a pigment, and the like. The resin additives may be used alone or as a mixture of two or more kinds.

The timing at which the optional components are added to the styrene resin and the kneading time are not particularly limited. For example, a process is exemplified in which the optional components are added to the styrene resin, and the mixture is dry- or wet-blended, and then the resulting mixture is supplied to the extruder and it is heat-melted, to which the foaming agent is added and mixed.

As the styrene resin composition, used in the present invention, the following styrene resin composition of first to fifth embodiments are preferable.

A styrene resin composition of a first embodiment contains the flame retardant in an amount of, preferably, 0.5 to 8.0 parts by weight relative to 100 parts by weight of the styrene resin. When the bromine-containing flame retardant is used as the flame retardant, the styrene resin composition of the first embodiment contains the bromine-containing flame retardant in an amount of 0.5 to 6.0 parts by weight, 1.0 to 5.0 parts by weight, or 1.5 to 4.0 parts by weight, relative to 100 parts by weight of the styrene resin.

In a styrene resin composition of a second embodiment, at least one flame retardant promoter selected from the radical generator and the phosphorus-containing flame retardant is added to the styrene resin composition of the first embodiment. The amount of the flame retardant added is the same amount as that in the styrene resin composition of the first embodiment. The radical generator is added in an amount of 0.05 to 0.5 parts by weight relative to 100 parts by weight of the styrene resin, and the phosphorus-containing flame retardant is added in an amount of 0.1 to 2 parts by weight relative to 100 parts by weight of the styrene resin.

In a styrene resin composition of a third embodiment, a radiation inhibitor is further added to the styrene resin composition of the second embodiment. The addition amounts of the flame retardant, and at least one flame retardant promoter selected from the radical generator and the phosphorus-containing flame retardant are the same amounts as those in the styrene resin composition of the second embodiment. The radiation inhibitor is added in an amount of 1.0 to 6.0 parts by weight or 2.0 to 5.0 parts by weight, relative to 100 parts by weight of the styrene resin.

In a styrene resin composition of a fourth embodiment, a water-absorptive substance is further added to the styrene resin composition of the third embodiment. The water-absorptive substance is added, as described below, when an alcohol is used as the other organic foaming agent and/or water is used as the inorganic foaming agent. In the styrene resin composition of the fourth embodiment, the addition amount of the flame retardant, at least one flame retardant promoter selected from the radical generator and the phosphorus-containing flame retardant, and the radiation inhibitor are the same amounts as those in the styrene resin composition of the third embodiment. The water-absorptive substance is added in an amount of 0.01 to 5 parts by weight or 0.1 to 3 parts by weight, relative to 100 parts by weight of the styrene resin.

In a styrene resin composition of a fifth embodiment, the stabilizer of flame retardant, the resin additive, or both of the stabilizer of flame retardant and the resin additive is added to the styrene resin composition of each of the first to fourth embodiments. The addition amounts of the stabilizer of flame retardant and the resin additive can be appropriately selected from a wide range depending on the kind of the styrene resin, the kinds and the amounts of the flame retardant, the flame retardant promoter, the radiation inhibitor, and the water-absorptive substance, which are used together, and the various physical properties of the extruded polystyrene foam to be obtained.

### [Foaming Agent]

Next, the foaming agent used in the present invention is explained. The foaming agent contains HFO and a specific organic foaming agent. In HFO, the ozone depleting potential is zero or very small and the global warming potential is considerably small, and thus HFO is a foaming agent which affects the environment only a little. Moreover, HFO has a low thermal conductivity in the gaseous state and is flame retardant. When it is used as the foaming agent for the extruded polystyrene foam, accordingly, the heat-insulating property and the flame retardance of the extruded polystyrene foam can be further improved.

HFO may include, for example, tetrafluoropropenes. The tetrafluoropropenes may include specifically, for example, trans-1,3,3,3-tetrafluoropropene (trans-HFO-1234ze), cis-1,3,3,3-tetrafluoropropene (cis-HFO-1234ze), 2,3,3,3-tetrafluoropropene (HFO-1234yf), and the like. The tetrafluoropropenes may be used alone or as a mixture of two or more kinds.

In the conventional extrusion-foaming of the styrene resin using HFO as the foaming agent, HFO having a relatively high solubility in the styrene resin and a relatively high compatibility with the styrene resin is used. Especially, HFO, which can be added to the styrene resin in a large amount, though it is easy to dissipate from the foam, and which has an excellent foaming capability as the foaming agent, is more preferably used, whereby an extruded polystyrene foam having a high foaming ratio have been obtained.

Meanwhile, in order to obtain the extruded polystyrene foam having a high foaming ratio using a tetrafluoropropene (HFO-1234ze, HFO-1234yf, or the like), which is HFO having low solubility in and compatibility with the styrene resin, it is necessary to add a large amount of the tetrafluoropropene. If that is done, the tetrafluoropropene is separated from the foamable melted product during the extrusion-foaming, the obtained extruded polystyrene foam has spots, which are locally largely recessed, on the surface, and the appearance of the foam may possibly be deteriorated. When a foam having a large thickness is produced, the closed cell ratio is reduced, and the long-term heat-insulating property may be reduced.

According to the present invention, however, even if the tetrafluoropropene is used as HFO, the extruded polystyrene foam, which has the high foaming ratio, the excellent long-term heat-insulating property, and the excellent appearance without spots or waves on the surface, can be obtained by using the tetrafluoropropene together with the specific organic foaming agent, and adjusting the thickness extension ratio A/a and the foaming pressure to the pre-determined ranges.

HFO is added in an amount of 0.030 mol or more and 0.125 mol or less, more preferably 0.035 mol or more and 0.115 mol or less, still more preferably 0.040 mol or more and 0.105 mol or less, particularly preferably 0.045 mol or more and 0.090 mol or less, relative to 100 g of the styrene resin. When the amount of HFO added is less than 0.030 mol relative to 100 g of the styrene resin, the effect of improving the heat-insulating property by HFO tends to be insufficient. On the other hand, when the amount of HFO added is more than 0.125 mol, relative to 100 g of the styrene resin, HFO is separated from the foamable melted product during the extrusion-foaming to generate spots on the surface of the obtained extruded polystyrene foam or to reduce the closed cell ratio of the foam, thus resulting in a tendency to affect the heat-insulating property.

The organic foaming agent, which is used together with HFO, may include saturated hydrocarbons having 3 to 5 carbon atoms such as propane, normal-butane, iso-butane (2-methylpropane), and cyclopentane; ethers such as dimethyl ether, diethyl ether, and methyl ethyl ether; alkyl chlorides such as methyl chloride and ethyl chloride; alcohols such as methanol, ethanol, propyl alcohol, isopropyl alcohol, butyl alcohol, sec-butyl alcohol, tert-butyl alcohol, aryl alcohol, crotyl alcohol, and prop argyl alcohol; ketones; esters; and the like. Of these, in terms of the combustibility, the dissipation from the extruded polystyrene foam, and the like, organic foaming agents having a polystyrene permeability of 0.5×10⁻¹⁰ cc·cm/cm²·s·cm Hg or more are preferable, organic foaming agents having a polystyrene permeability of 1.0×10⁻¹⁰ cc·cm/cm²·s·cm Hg or more are more preferable, and organic foaming agents containing no foaming agent having a polystyrene permeability of less than 0.5×10⁻¹⁰ cc·cm/cm²·s·cm Hg are still more preferable. The organic foaming agents may be used alone or as a mixture of two or more kinds thereof.

The organic foaming agent as described above has a high effect of plasticizing the styrene resin and causes the foaming of the foamable melted product containing the styrene resin, the foaming agent, the flame retardant, and the other optional components at an appropriate viscosity, and thus it is necessary in order to obtain a desired extruded polystyrene foam. Meanwhile, as described above, when an organic foaming agent having a high polystyrene permeability and capable of quickly dissipating after the extruded polystyrene foam is obtained is selected, the excellent processability and foamability can be obtained in the production of the extruded foam, and the excellent flame retardance can be provided to the extruded foam.

In the present invention, the other organic foaming agent, which is used together with HFO, is not particularly limited so long as it has a polystyrene permeability of 0.5×10⁻¹⁰ cc·cm/cm²·s·cm Hg or more, and ethers and alkyl chlorides are preferable, because they have a high effect of plasticizing the styrene resin and a fast polystyrene permeability. Of these, dimethyl ether, methyl chloride, and ethyl chloride are more preferable, and especially dimethyl ether has a high polystyrene permeability (a fast permeability rate to polystyrene) and has a small environmental load, and thus it is particularly preferable. The organic foaming agents may be used alone or as a mixture of two or more kinds.

The polystyrene permeability of the foaming agent in the present invention can be obtained, for example, by fixing a polystyrene resin film having a thickness of 50 to 100 μm, produced by heating, melting, and pressing a polystyrene resin (tradename: G9401 manufactured by PS Japan Corporation) on a differential pressure type gas permeability apparatus (tradename: GTR-31A manufactured by GTR Tec Corporation) provided with a gas chromatograph (tradename: G2700T manufactured by Yanaco Analytical Systems Inc.), and measuring a permeation amount at a temperature of 23° C.±2° C. in dry conditions according to a differential pressure method. One example of the polystyrene permeability of the foaming agent, measured as above, is shown in Table 1.

TABLE 1

| | Polystyrene permeability |
|---|---|
| Organic foaming agent | (×10⁻¹⁰ cc · cm/cm² · s · cmHg) |
| Propane | 0.030 |
| normal-Butane | 0.015 |
| iso-Butane | 0.005 |
| Dimethyl ether | 3.30 |
| Methyl chloride | 7.26 |
| Ethyl chloride | 1.00 |

The total addition amount of HFO and the other organic foaming agent is preferably 0.105 mol or more and 0.300 mol or less, more preferably 0.115 mol or more and 0.200 mol or less, relative to 100 g of the styrene resin. When the total addition amount is less than 0.105 mol, relative to 100 g of the styrene resin, the foamable melted product containing the styrene resin, the foaming agent, the flame retardant, and the other optional components does not have a viscosity appropriate for obtaining the desired extruded foam upon the foaming, and it tends to obtain only an extruded polystyrene foam having a closed cell ratio of less than 90% and/or a high apparent density. When the total addition amount is more than 0.300 mol relative to 100 g of the styrene resin, inferiors such as voids may be generated in the extruded polystyrene foam due to the excess amount of the foaming agent.

In the present invention, HFO is used in a range of 0.030 to 0.125 mol, 0.035 to 0.115 mol, 0.040 to 0.105 mol, or 0.045 to 0.090 mol, relative to 100 g of the styrene resin, and HFO and the other organic foaming agent are used in a range of 0.105 to 0.300 mol or 0.115 to 0.200 mol in total, relative to 100 g of the styrene resin.

In the present invention, an inorganic foaming agent such as carbon dioxide or water may be used, if necessary, together with HFO and the other organic foaming agent. They may be used alone or as a mixture of two or more kinds. When the inorganic foaming agent is used, good effects of plasticizing and aiding the foaming can be obtained, the extrusion pressure is reduced, and the extruded polystyrene foam can be further stably produced.

In the present invention, when the alcohol is used as the other organic foaming agent and/or water is used as the inorganic foaming agent, in order to stably perform the extrusion-foaming, it is preferable to add the water-absorptive substance to the styrene resin composition. The water-absorptive substance used in the present invention may specifically include water-absorptive polymer compounds such as polyacrylate polymers, starch-acrylic acid graft-copolymers, polyvinyl alcohol polymers, vinyl alcohol-acrylate copolymers, ethylene-vinyl alcohol copolymers, acrylonitrile-methyl methacrylate-butadiene copolymers, polyethylene oxide copolymers, and derivatives thereof; fine powders having a particle size of 1000 nm or less and having hydroxyl groups on the surface thereof; water-absorptive or water-swellable layered silicates such as smectite, swellable fluorine mica, and bentonite, and organized products thereof; porous substances such as zeolite, activated carbon, alumina, silica gel, porous glass, activated clay, and diatom earth; and the like. The fine powder having a particle size of 1000 nm or less and having hydroxyl groups on the surface may include anhydrous silica (silicon oxide) having silanol groups (—SiH₃OH) on the surface. Various commercial products of anhydrous silica are known, and they may include, for example, tradename: AEROSIL manufactured by Nippon Aerosil Co., Ltd., and the like. The water-absorptive substances may be used alone or as a mixture of two or more kinds. The amount of the water-absorptive substance added is appropriately adjusted depending on the amount of the alcohol and water added, and it is preferably 0.01 parts by weight or more and 5 parts by weight or less, more preferably 0.1 parts by weight or more and 3 parts by weight or less, relative to 100 parts by weight of the styrene resin.

### [Extrusion-Foaming Method]

The method for producing an extruded polystyrene foam of the present invention, for example, contains a step (1) wherein a styrene resin composition is supplied to an extruder, the composition is melted and/or plasticized by heating to knead it, whereby a resin melted product is obtained; a step (2) wherein a foaming agent is added to the resin melted product obtained in step (1) to obtain a foamable melted product; and a step (3) in which the foamable melted product is extruded through a die slit section provided on the extruder to a zone having a lower pressure than that of the inside of the extruder to foam it, whereby a plate-shaped foam is formed.

In the production method of the present invention, the extruder used for melt-kneading the styrene resin composition is not particularly limited, and may include, for example, screw extruders such as a single-screw extruder, a twin-screw extruder, and a multi-screw extruder, plunger extruders, gear pump extruders, and the like. Of these, the screw extruder is preferable in terms of the production efficiency, and the like. The extruder may be provided with a cooling apparatus on the downstream side, or two or more extruders may be connected. The die slit section (mouthpiece) is generally provided on the downstream side of the extruder, and when the cooling apparatus is connected on the downstream side of the extruder, it is provided on the downstream side of the cooling apparatus. The opening in the thickness direction is a (mm). Further, a molding die is located so that it is connected or is adjacent to the die slit section, and a molding roll is located adjacent to the downstream side of the molding die. A shape is given to the foam extruded through the die slit section by the molding die, and it is further formed by the molding roll, whereby an extruded polystyrene foam is formed.

Here, for example, the thickness extension ratio A/a can be adjusted to the pre-determined range described above by adjusting the opening a (mm) in thickness direction of the die slit section and/or the thickness A (mm) of the obtained extruded polystyrene foam.

In the step (1), the heating temperature of the styrene resin composition is enough to be a temperature at which the styrene resin contained in the composition melts or higher. The temperature is preferably a temperature at which the molecular deterioration of the resin, caused by the influence of the optional components, is suppressed as much as possible, for example, about 150 to 260° C. The melt-kneading time is not univocally decided, because it varies depending on the extrusion amount of the styrene resin composition per unit time, and the kind of the extruder used as the melt-kneading means, and thus the time is appropriately decided as a time necessary for uniformly dispersing and mixing the styrene resin, the foaming agent, and the optional components.

In the step (2), a pressure when the foaming agent is added or injected to the resin melted product is not particularly limited, and may be a pressure higher than the inside pressure of the extruder or the like. The addition or the injection of the foaming agent to the resin melted product is performed, for example, in the extruder, whereby the foamable melted product is obtained. The step (1) and the step (2) are performed in the extruder.

In the step (3), the foamable melted product in the extruder is extruded through the die slit section to a zone having a lower pressure than that of the inside of the extruder to foam it, and the obtained foam is put in a molding die and molded. The molding can be performed, for example, in a manner in which the die slit section is disposed adjacent to the molding die so that an inside of the die slit section is communicated with an inside space in the molding die (space for molding) through an outlet of the die slit section, and the foam, extruded through the die slit section, is directly put in the inside space in the molding die. Here, the thickness extension ratio A/a, which is the ratio of the opening a (mm) in thickness direction of the die slit section and the thickness A of the extruded polystyrene foam finally obtained, is adjusted to 18 or less, preferably 3 or more and 18 or less, more preferably 4 or more and 15 or less, still more preferably 5 or more and 10 or less, and the foaming pressure, which is applied to the foamable melted product, just before the extrusion-foaming of the foamable melted product through the die slit section, is adjusted to 4.5 MPa or more and 10.0 MPa or less, preferably 4.5 MPa or more and 8.0 MPa or less. The foam, which is extruded through the die slit section and formed in the molding die, can be used as the extruded polystyrene foam of the present invention as it is, but it is preferable that the foam is formed into a plate-shaped foam having a large cross-sectional area using the molding roll, which is disposed adjacent to the downstream side of the molding die. A desired cross-sectional shape, surface property, and quality of the foam can be obtained by adjusting a shape of a fluidized surface of the molding die and a temperature of the.

The foaming pressure (pressure applied to the foamable melted product just before extrusion through the die slit section) can be adjusted, for example, by adjusting a temperature of the die slit section, a temperature of the molding die whose inside space is directly connected to the outlet of the die slit section, the opening of the outlet of the die slit section, or the like. The direction of the opening of the outlet of the die slit section here is not limited to the thickness direction, and may be a width direction or both of the thickness direction and the width direction. In order to increase the foaming pressure, the die temperature may be decreased or the opening of the outlet of the die slit section may be made smaller. One specific example of the adjustment of the foaming pressure applied to the foamable melted product may include, for example, a method in which the opening a in thickness direction of the outlet of the die slit section is adjusted to a range of about 1.0 to 15.0 mm and the temperature of the die slit section is adjusted to 70 to 90° C., though it is depends on the discharge amount of the foamable melted product through the die slit section.

Thus, the extruded polystyrene foam which is lightweight, has the excellent heat-insulating property and flame retardance, and has the improved appearance can be easily obtained according to the present invention.

The extruded polystyrene foam, obtained by the present invention, has a thickness A of 10 mm or more and 150 mm or less, preferably 15 mm or more and 120 mm or less, more preferably 20 mm or more and 100 mm or less, in terms of the heat-insulating property, the bending strength, and the compression strength, taking into account the foam functions as a heat-insulating material for building or as a heat-insulating material for a cooling box or a refrigerator truck for example.

The extruded polystyrene foam, obtained by the present invention, has the following density (apparent density), closed cell ratio, average void content, cell deformation ratio, and thermal conductivity.

### [Apparent Density]

The extruded polystyrene foam, obtained by the present invention, has a density (apparent density) of 20 kg/m³ or more and 45 kg/m³ or less, preferably 25 kg/m³ or more and 40 kg/m³ or less, in terms of the heat-insulating property and the lightness, taking into account the foam functions as a heat-insulating material for building or a heat-insulating material for a cooling box or a refrigerator truck, for example. The calculation method of the apparent density is described in detail in Examples.

### [Closed Cell Ratio]

The extruded polystyrene foam, obtained by the present invention, has a closed cell ratio of 90% or more, preferably 95% or more. When the closed cell ratio is too low, hydrofluoroorefin, used as the foaming agent, is dissipated from the extruded polystyrene foam during an early stage, and the long-term heat-insulating property may possibly be deteriorated. In the present invention, the closed cell ratio (%) of the extruded polystyrene foam is measured according to Procedure C in ASTM-D2856-70 using an air-comparison pycnometer (for example, Model 1000 type, manufactured by Tokyoscience Co., Ltd.).

The closed cell ratio of the extruded polystyrene foam, obtained by the present invention is obtained in a manner in which samples having a length of 25 mm×a width of 25 mm×a thickness of 20 mm are obtained from total 3 points, i.e., the central part and both end parts, in the width direction on the extruded polystyrene foam, a closed cell ratio of each sample is calculated according to the following formula (1), and an arithmetical mean is obtained from the closed cell ratios at the three points.

Closed cell ratio(%)=(Vx−W/ρ)×100/(VA−W/ρ) (1)

wherein Vx, VA, W, and ρ are as follows:
Vx: A true volume of a sample measured using the air-comparison pycnometer (cm³; a sum of a volume of a resin forming the sample of the extruded polystyrene foam and a total volume of voids of closed cells in the sample)
VA: An apparent volume (cm³) of the sample calculated from an outer size of the sample
W: A total weight (g) of the sample
ρ: A density (g/cm³) of the styrene resin forming the extruded polystyrene foam

### [Average Cell Diameter]

The extruded polystyrene foam, obtained by the present invention, has an average cell diameter (D_{T}) in the thickness direction of preferably 0.5 mm or less, more preferably 0.05 to 0.3 mm, in terms of the heat-insulating property.

An average cell diameter (D_{T}: mm) in the thickness direction is obtained in a manner in which straight lines are drawn in a thickness direction over the all thickness of the extruded polystyrene foam on total 3 points, i.e., the central part and both end parts on a vertical section in the width direction of an enlarged microphotograph, an average diameter of cells existing on each straight line (the length of the straight line/the number of cells crossing the straight line) is obtained from the length of each straight line and the number of cells crossing the straight line, and an arithmetical mean is obtained from the average diameters obtained at the 3 points, which is defined as an average cell diameter (D_{T}: mm) in the thickness direction.

An average cell diameter (D_{W}: mm) in the width direction is obtained in a manner in which straight lines having a length of 3 mm times a rate of magnification are drawn in a width direction in a position that bisects the extruded polystyrene foam in the thickness direction on total 3 points, i.e., the central part and both end parts on a vertical section in the width direction of an enlarged microphotograph, an average diameter of cells existing on each straight line is obtained from the straight line and the number of the cells crossing the straight line using a formula [3 mm/(the number of cells crossing the straight line-1)], and an arithmetical mean is obtained from the average diameters obtained at the 3 points, which is defined as an average cell diameter (D_{W}: mm) in the width direction.

An average cell diameter (D_{L}: mm) in the extrusion direction is obtained in a manner in which straight lines having a length of 3 mm times a rate of magnification are drawn in an extrusion direction in a position that bisects the extruded polystyrene foam in the thickness direction on total 3 points, i.e., the central part and both end parts on a vertical section in the extrusion direction obtained by cutting the extruded polystyrene foam in the extrusion direction at a position that bisects the extruded polystyrene foam in the width direction of an enlarged microphotograph, an average diameter of cells existing on each straight line is obtained from the straight line and the number of the cells crossing the straight line using a formula [3 mm/(the number of cells crossing the straight line-1)], and an arithmetical mean is obtained from the average diameters obtained at the 3 points, which is defined as an average cell diameter (D_{L}: mm) in the extrusion direction. An average cell diameter (D_{H}: mm) in a horizontal direction of the extruded polystyrene foam is an arithmetical mean of D_{W} and D_{L}.

### [Cell Deformation Ratio]

The extruded polystyrene foam, obtained by the present invention, has preferably a cell deformation ratio of 0.7 to 2.0. The cell deformation ratio refers to a value (D_{T}/D_{H}) obtained by dividing the average cell diameter (D_{T}: mm) in the thickness direction, obtained by the measurement method described above, by the average cell diameter (D_{H}: mm) in the horizontal direction of the extruded polystyrene foam. The cells become more flat as the cell deformation ratio becomes smaller than 1, and become vertically longer as the cell deformation ratio becomes larger than 1. When the cell deformation ratio is too small, the compression strength tends to be decreased because of the flat cells, and the dimensional stability of the extruded polystyrene foam tends to be deteriorated because the flat cells have the strong tendency to return to a spherical shape. When the cell deformation ratio is too large, the effect of improving the heat-insulating property by the cell shape is decreased because the number of cells in the thickness direction is decreased. The cell deformation ratio, accordingly, is more preferably from 0.8 to 1.5, still more preferably from 0.8 to 1.2. When the cell deformation ratio is within the range described above, the extruded polystyrene foam having the excellent mechanical strength, and the high heat-insulating property is formed.

### [Thermal Conductivity]

The extruded polystyrene foam, obtained by the present invention, has a thermal conductivity of preferably 0.0290 W/(m·K) or less, more preferably 0.0280 W/(m·K) or less, after 100 days from the production. In the present invention, the extruded polystyrene foam has a high closed cell ratio, and the dissipation of hydrofluoroolefin from the foam can be effectively prevented, and thus the thermal conductivity is maintained low and the heat-insulating property is excellent even after 100 days from the production.

In the present invention, the thermal conductivity is measured according to a method based on a promotion test described in ISO 11561. A test piece, having a thickness of 10 mm×a length of 200 mm×a width of 200 mm and having no molded skin, is cut from the central part in the thickness direction and the width direction on the extruded polystyrene foam just after the production, and the test piece is allowed to stand in a standard temperature condition Class 3 (23° C±5° C.) provided in JIS K 7100 and a standard humidity condition Class 3 (50+20, −10% R.H.). After 100 days from the production, the thermal conductivity is measured using the test piece according to the method based on JIS A 1412-2: 1999 in a temperature condition of an average temperature of 23° C.

In order to adjust the thermal conductivity to 0.0280 W/mK or less after 100 days from the production of the extruded polystyrene foam, as described above, it is enough to adjust the amount of the hydrofluoroolefin added, the density (apparent density), the closed cell ratio, the average cell diameter, and the cell deformation ratio of the extruded polystyrene foam to the ranges defined in the present invention or the preferable ranges.

The extruded polystyrene foam, obtained by the present invention, has a density (apparent density) within a range of 20 to 45 kg/m³ or 25 to 40 kg/m³, a closed cell ratio within a range of 90% or more, or 95% or more, and a thickness A (mm) within a range of 10 to 150 mm, 15 to 120 mm, or 20 to 100 mm. In the present invention, the extruded polystyrene foam is preferable which has at least one property selected from the group consisting of an average cell diameter (either of an average cell diameter DT in the thickness direction, an average cell diameter D_{W} in the width direction, and an average cell diameter D_{L} in the extrusion direction) within a range of 0.5 mm or less, or 0.05 to 0.3 mm, a cell deformation ratio within a range of 0.7 to 2.0, 0.8 to 1.5, or 0.8 to 1.2, and a thermal conductivity within a range of 0.0290 W/(m·k) or less, or 0.0280 W/(m·k) or less after 100 days from the production, as well as has the density, the closed cell ratio, and the thickness A described above.

### EXAMPLE

Examples of the present invention are explained below. The present invention, of course, is not limited to Examples below. In Examples and Comparative Examples below, “parts” means “parts by weight.”

Starting materials used in Examples and Comparative Examples are as follows:

### [Substrate Resin]

Styrene Resin A (polystyrene, tradename: G9401, MFR: 2.2 g/10 minutes, manufactured by PS Japan Corporation)

Styrene resin B (polystyrene, tradename: 680, MFR: 7.0 g/10 minutes, manufactured by PS Japan Corporation)

### [Heat Ray Radiation Inhibitor]

Graphite (tradename: M-885, flake graphite, a primary particle size of 5.5 μm, a fixed carbon content of 89%, manufactured by Marutoyo Co., Ltd.)

### [Flame Retardant]

Bromine-containing flame retardant 1: a mixture of tetrabromobisphenol A-bis(2,3-dibromo-2-methylpropyl)ether and tetrabromobisphenol A-bis(2,3-dibromopropyl)ether (tradename: GR-125P, manufactured by Daiichi Kogyo Co., Ltd.)

Bromine-containing flame retardant 2: brominated styrene-butadiene block copolymer (tradename: Emerald Innovation #3000, manufactured by Chemtura Japan)

### [Flame Retardant Promoter]

Triphenyl phosphine oxide (manufactured by Sumitomo Shoji Chemicals Co., Ltd.)

Poly-1,4-diisopropylbenzene (tradename: CCPIB, manufactured by United Initiators GmbH & Co. Kg.)

### [Stabilizer of Flame Retardant]

Stabilizer 1: a bisphenol A-diglycidylether epoxy resin (tradename: ADK CIZER EP-13, manufactured by ADEKA Corporation)

Stabilizer 2: a cresol novolac epoxy resin (tradename: ECN-1280, manufactured by Huntsman Japan KK)

Stabilizer 3: a reaction mixture of dipentaerythritol-adipic acid (tradename: Plenlizer™ ST210, manufactured by Ajinomoto Fine-Techno Co., Ltd.)

Stabilizer 4: pentaerythritol tetrakis[3-(3′,5′-di-tert-butyl-4′-hydroxyphenyl)propionate] (tradename: ANOX 20, manufactured by Chemtura Japan)

Stabilizer 5: 3,9-bis(2,4-di-tert-butylphenoxy)-2,4,8,10-tetraoxa-3,9-diphosphaspiro[5.5]undecane (tradename: Ultranox 626, manufactured by Chemtura Japan)

Stabilizer 6: triethyleneglycol-bis-3-(3-tert-butyl-4-hydroxy-5-methylphenyl)propionate (tradename: Songnox 2450 FF, manufactured by Songwon International Japan K.K.)

### [Resin Additive]

Calcium stearate (a lubricant, tradename: SC-P, manufactured by Sakai Chemical Industry Co., Ltd.)

Bentonite (a water-absorptive substance, tradename: Bengel Bright K11, manufactured by Hojun Co., Ltd.)

Silica (a water-absorptive substance, tradename: Carplex™ BS-304F, manufactured by Evonik Japan)

### [Foaming Agent]

HFO-1234ze (manufactured by Honeywell Japan Inc.)

Dimethyl ether (manufactured by Iwatani Corporation)

Ethyl chloride (manufactured by Nihon Tokushu Kagaku Kogyo Kabushiki Kaisha)

Water (tap water in Settsu-Shi, Osaka-Fu)

The properties (the apparent density, the closed cell ratio, the average cell diameter, the cell deformation ratio, the residual amount of HFO-1234ze relative to 100 g of the styrene resin in the extruded foam, the thermal conductivity, the JIS combustibility, and the appearance) of the extruded polystyrene foams obtained in Examples and Comparative Examples were evaluated according to the following methods.

(1) Apparent Density (kg/m³)

A weight as well as sizes of a length, a width, and a thickness of the obtained extruded polystyrene foam were measured. A density of the foam was obtained from the measured weight and the sizes according to the following formula, and the unit is converted to kg/m³.

Apparent density (g/cm³)=Weight of foam (g)/Volume of foam (cm³)

### (2) Closed Cell Ratio (%)

A test piece, having a thickness of 20 mm (when the thickness was less than 20 mm, the maximum thickness after the molded skin was peeled off)×a length of 25 mm×a width of 25 mm and having no molded skin, was cut from the obtained extruded polystyrene foam, and the ratio was evaluated according to Procedure C in ASTM-D2856-70.

### (3) Average Cell Diameter (mm)

The method for measuring the average cell diameter in the thickness direction is as described above.

### (4) Cell Deformation Ratio

The evaluation was made as described above. The method for measuring the cell deformation ratio is as described above.

(5) Residual Amount (mol) of HFO-1234ze Relative to 100 g of Styrene Resin in Extruded Foam

The obtained extruded polystyrene foam was allowed to stand in a standard temperature condition Class 3 (23° C.±5° C.) provided in JIS K 7100 and a standard humidity condition Class 3 (50+20, −10% R.H.). Residual amounts of HFO-1234ze were evaluated by using the following facility and procedure just after the production and after 100 days from the production. In the present invention, the term “just after the production” refers to a time in 5 hours from the extrusion-foaming of the extruded polystyrene foam released from the extruder.
a) Instrument used: Gas chromatograph GC-2014 (tradename, manufactured by Shimadzu Corporation)
b) Column used: G-Column G-950 25UM (tradename, manufactured by Chemicals Evaluation and Research Institute, Japan)
c) Measurement conditions:
   Inlet temperature: 65° C.
   Column temperature: 80° C.
   Detector temperature: 100° C.
   Carrier gas: high purity helium
   Flow rate of carrier gas: 30 mL/minute
   Detector: TCD
   Current: 120 mA

To an about 130 cc sealable glass vessel (hereinafter referred to as a “sealable vessel”) was added about 1.2 g of a test piece, cut from the extruded polystyrene foam, and the air in the sealable vessel was removed by using a vacuum pump. After that, the sealable vessel was heated at 170° C. for 10 minutes to bring out the foaming agent in the extruded polystyrene foam into the sealable vessel. After the temperature of the sealable vessel was returned to an ordinary temperature, the pressure in the sealable vessel was returned to the atmospheric pressure by introducing helium, and then 40 μL of a mixed gas containing HFO-1234ze (mixed gas containing HFO-1234ze 40 μL) was taken out by using a microsyringe. The evaluation was made using the instrument and measurement conditions of a) to c) described above. The size of each test piece slightly varies depending on the apparent density of the extruded polystyrene foam.

### (6) Thermal Conductivity (W/mK)

The thermal conductivity of the foam was measured according to a method based on a promotion test described in ISO 11561. A test piece, having a thickness of 10 mm×a length of 200 mm×a width of 200 mm and having no molded skin, was cut from the central part in the thickness direction and the width direction on the extruded polystyrene foam just after the production, and the test piece was allowed to stand in a standard temperature condition Class 3 (23° C.±5° C.) provided in JIS K 7100 and a standard humidity condition Class 3 (50+20, −10% R.H.). After 100 days from the production, the thermal conductivity was measured using the test piece according to the method based on JIS A 1412-2: 1999 in a temperature condition of an average temperature of 23° C. Evaluation was made according to the following criteria:
⊚ (acceptance): A thermal conductivity of 0.0280 W/mK or less.
◯ (acceptance): A thermal conductivity of more than 0.0280 W/mK and 0.0290 W/mK or less.
× (nonacceptance): A thermal conductivity of more than 0.0290 W/mK.
   (7) JIS combustibility

According to JIS A 9511 (Measurement method A), the evaluation was made using 5 test pieces having a thickness of 10 mm×a length of 200 mm×a width of 25 mm based on the following criteria. After the production of the extruded polystyrene foam, the test pieces having the sizes described above were cut therefrom, they were allowed to stand in a standard temperature condition Class 3 (23° C.±5° C.) provided in JIS K 7100 and a standard humidity condition Class 3 (50+20, −10% R.H.), and the measurement was performed after one week from the production.
◯ (acceptance): A standard in which flame disappeared in 3 seconds, there was no dust, and combustion did not occur over the flammable limit pointing line is satisfied.
× (nonacceptance): The above standard is not satisfied.

### (8) Appearance

The appearance of the obtained extruded polystyrene foam was visually observed, and whether or not pores and waves were generated on the surface was examined.

### Example 1

### [Production of Styrene Resin Composition]

As shown in Component in Table 2, 100 parts of the styrene resin 1(tradename: G9401) was dry-mixed with 3 parts of the bromine-containing flame retardant 1 (flame retardant, tradename: GR-125P), 1.0 part of triphenylphosphine oxide (flame retardant promoter), 0.10 parts of the stabilizer 1 (bisphenol A-glycidyl ether, tradename: EP-13), 0.20 parts of the stabilizer 6 (triethyleneglycol-bis-3-(3-t-butyl-4-hydroxy-5-methylphenyl)propionate, tradename: Songnox 2450FF), and 0.10 parts of calcium stearate (lubricant, tradename: SC-P) to obtain a styrene resin composition.

### [Production of Extruded Foam]

An extruder in which a first extruder (single-screw extruder having an aperture of 65 mm), a second extruder (single-screw extruder having an aperture of 90 mm), and a cooling apparatus were connected in series in this order was used as an extruder for extrusion-foaming. A die slit section (mouthpiece) having a rectangular section with an opening (a) in the thickness direction of 4.3 mm×a width of 50 mm was disposed on the tip opposite to the second extruder in the cooling apparatus. A molding die is disposed in close contact with the die slit section, and a molding roll is disposed on the downstream side of the molding die.

The styrene resin composition, obtained as above, was supplied to the first extruder of the extruder at about 50 kg/hour, and was heated to 240° C. and melted and kneaded. Into the obtained resin melted product was injected a foaming agent (5.5 parts of HFO-1234ze and 4.3 parts of dimethyl ether, relative to 100 parts of the styrene resin) at a position of the first extruder near the tip of the second extruder to form a foamable melted product. The obtained foamable melted product was cooled to 128° C. in the second extruder connected to the first extruder and the cooling apparatus.

As shown in the production conditions in Table 2, by adjusting the die slit section opening a in thickness direction to 4.3 mm, and adjusting the temperature of the die slit section to 80° C., a foaming pressure, applied to the foamable melted product in the die slit section was adjusted to 5.0 MPa and, just after that, the foamable melted product was extrusion-foamed through the die slit section into the inside of the molding die whose inside pressure was the atmospheric pressure to form it, and the shape thereof was arranged by the molding roll, whereby a plate-shaped extruded polystyrene foam having cross-sectional size of a thickness of 36 mm×a width of 230 mm was obtained. Evaluation results of the foam are shown in Table 2.

### Examples 2 to 9

An extruded polystyrene foam was obtained in the same manner as in Example 1, except that the kinds, the addition amounts (parts) of the various components and the production conditions were changed as shown in Table 2. In Example 9, graphite was thrown into the styrene resin in a state of a master batch. The master batch has a mixed concentration of 50% by weight/50% by weight of the styrene resin/the graphite. Evaluation results of each obtained foam were shown in Table 2.

### Comparative Examples 1 to 3

An extruded polystyrene foam was obtained in the same manner as in Example 1, except that the kinds, the addition amounts (parts) of the various components and the production conditions were changed as shown in Table 3. Evaluation results of each obtained foam were shown in Table 3.

In Table 2 and Table 3, numerical values of the components whose unit is expressed by “parts” are the addition amount of the substrate resin, the foaming agent, and the optional components, and a numerical value of the foaming agent whose unit is expressed by “mol” is the addition amount of the foaming agent relative to 100 g of the substrate resin (styrene resin). In the physical properties of the extruded polystyrene foam in Table 2 and Table 3, the residual amount of HFO-1234ze is the residual amount, represented by mol number, of HFO-1234ze relative to 100 g of the substrate resin (styrene resin) in the extruded foam. In the production conditions in Table 2 and Table 3, the foaming pressure is a pressure applied to the foamable melted product just before the extrusion through the die slit section.

TABLE 2

| | | | | Example 1 | Example 2 | Example 3 | Example 4 | Example 5 |
|---|---|---|---|---|---|---|---|---|
| Composition | Substrate resin | Styrene resin 1 | parts | 100 | 100 | 100 | 100 | 100 |
| | | Styrene resin 2 | parts | 0 | 0 | 0 | 0 | 0 |
| | Radiation inhibitor | Graphite | parts | 0 | 0 | 0 | 0 | 0 |
| | Flame retardant | Bromine-containing | parts | 3.0 | 3.0 | 3.0 | 3.0 | 3.0 |
| | | flame retardant 1 | | | | | | |
| | | Bromine-containing | parts | 0 | 0 | 0 | 0 | 0 |
| | | flame retardant 2 | | | | | | |
| | Flame retardant | Triphenyl phosphine | parts | 1.0 | 1.0 | 1.0 | 1.0 | 1.0 |
| | promoter | oxide | | | | | | |
| | | Poly-1,4-diisopropyl | parts | 0 | 0 | 0 | 0 | 0 |
| | | benzene | | | | | | |
| | Stabilizer | Stabilizer 1 | parts | 0.10 | 0.10 | 0.10 | 0.10 | 0.10 |
| | | Stabilizer 2 | parts | 0 | 0 | 0 | 0 | 0 |
| | | Stabilizer 3 | parts | 0 | 0 | 0 | 0 | 0 |
| | | Stabilizer 4 | parts | 0 | 0 | 0 | 0 | 0 |
| | | Stabilizer 5 | parts | 0 | 0 | 0 | 0 | 0 |
| | | Stabilizer 6 | parts | 0.20 | 0.20 | 0.20 | 0.20 | 0.20 |
| | Lubricant | Calcium stearate | parts | 0.10 | 0.10 | 0.10 | 0.10 | 0.10 |
| | Water-absorptive | Bentonite | parts | 0 | 0 | 0 | 0 | 0 |
| | medium | Silica | parts | 0 | 0 | 0 | 0 | 0 |
| | Foaming agent | HFO-1234ze | parts | 5.5 | 6.5 | 7.5 | 7.5 | 7.5 |
| | | | mol | 0.048 | 0.057 | 0.066 | 0.066 | 0.066 |
| | | Dimethyl ether | parts | 4.3 | 3.9 | 3.5 | 3.5 | 3.5 |
| | | | mol | 0.093 | 0.085 | 0.076 | 0.076 | 0.076 |
| | | Ethyl chloride | parts | 0 | 0 | 0 | 0 | 0 |
| | | | mol | 0 | 0 | 0 | 0 | 0 |
| | | Water | parts | 0 | 0 | 0 | 0 | 0 |
| | | Total amount of | mol | 0.142 | 0.142 | 0.142 | 0.142 | 0.142 |
| | | foaming agents | | | | | | |
| | | excluding water | | | | | | |
| Production | Foaming temperature | | ° C. | 128 | 128 | 129 | 128 | 128 |
| condition | Foaming pressure | | MPa | 5.0 | 6.0 | 7.0 | 6.8 | 7.3 |
| | Opening a in thickness direction of die slit | | mm | 4.3 | 3.6 | 3.0 | 3.0 | 3.0 |
| | section | | | | | | | |
| | Thickness extension ratio A/a | | — | 8.4 | 8.3 | 8.3 | 6.0 | 15.0 |
| | Temperature of die slit section | | ° C. | 80 | 80 | 80 | 80 | 80 |
| Properties of | Thickness A of extruded foam | | mm | 36 | 30 | 25 | 18 | 45 |
| extruded foam | Apparent density | | kg/m³ | 35 | 35 | 35 | 35 | 35 |
| | Closed cell ratio | | % | 95 | 95 | 95 | 96 | 95 |
| | Average cell diameter | | mm | 0.1 | 0.1 | 0.1 | 0.1 | 0.1 |
| | Cell deformation ratio | | — | 1.0 | 1.0 | 1.0 | 0.9 | 1.2 |
| | Residual amount of | just after production | mol | 0.046 | 0.054 | 0.063 | 0.063 | 0.063 |
| | HFO-1234ze | after 100 days from | mol | 0.043 | 0.052 | 0.060 | 0.060 | 0.060 |
| | | production | | | | | | |

| | | | | | | |
|---|---|---|---|---|---|---|
| Thermal conductivity after 100 days from | W/mK | 0.0275 | 0.0271 | 0.0265 | 0.0263 | 0.0271 |
| production | | | | | | |
| JIS combustibility | — | ◯ | ◯ | ◯ | ◯ | ◯ |
| Appearance of foam | — | good | good | good | good | good |

| | | | | Example 6 | Example 7 | Example 8 | Example 9 |
|---|---|---|---|---|---|---|---|
| Composition | Substrate resin | Styrene resin 1 | parts | 100 | 100 | 0 | 100 |
| | | Styrene resin 2 | parts | 0 | 0 | 100 | 0 |
| | Radiation inhibitor | Graphite | parts | 0 | 0 | 0 | 2.5 |
| | Flame retardant | Bromine-containing | parts | 3.0 | 3.0 | 0 | 3.0 |
| | | flame retardant 1 | | | | | |
| | | Bromine-containing | parts | 0 | 0 | 3.0 | 0 |
| | | flame retardant 2 | | | | | |
| | Flame retardant | Triphenyl phosphine | parts | 1.0 | 1.0 | 0.5 | 1.0 |
| | promoter | oxide | | | | | |
| | | Poly-1,4-diisopropyl | parts | 0 | 0 | 0.10 | 0 |
| | | benzene | | | | | |
| | Stabilizer | Stabilizer 1 | parts | 0.10 | 0.10 | 0.15 | 0.20 |
| | | Stabilizer 2 | parts | 0 | 0 | 0.15 | 0 |
| | | Stabilizer 3 | parts | 0 | 0 | 0.20 | 0.10 |
| | | Stabilizer 4 | parts | 0 | 0 | 0.30 | 0 |
| | | Stabilizer 5 | parts | 0 | 0 | 0.015 | 0 |
| | | Stabilizer 6 | parts | 0.20 | 0.20 | 0 | 0.20 |
| | Lubricant | Calcium stearate | parts | 0.10 | 0.10 | 0.10 | 0.20 |
| | Water-absorptive | Bentonite | parts | 0 | 0.2 | 0 | 0 |
| | medium | Silica | parts | 0 | 0.2 | 0 | 0 |
| | Foaming agent | HFO-1234ze | parts | 7.5 | 7.5 | 7.5 | 7.5 |
| | | | mol | 0.066 | 0.066 | 0.066 | 0066 |
| | | Dimethyl ether | parts | 0 | 2.2 | 3.5 | 3.5 |
| | | | mol | 0 | 0.048 | 0.076 | 0076 |
| | | Ethyl chloride | parts | 5.0 | 0 | 0 | 0 |
| | | | mol | 0.078 | 0 | 0 | 0 |
| | | Water | parts | 0 | 0.5 | 0 | 0 |
| | | Total amount of | mol | 0.143 | 0.114 | 0.142 | 0.142 |
| | | foaming agents | | | | | |
| | | excluding water | | | | | |

| | | | | | | |
|---|---|---|---|---|---|---|
| Production | Foaming temperature | ° C. | 129 | 125 | 125 | 128 |
| condition | Foaming pressure | MPa | 7.0 | 6.9 | 7.0 | 7.0 |
| | Opening a in thickness direction of die slit | mm | 3.0 | 3.0 | 3.0 | 3.0 |
| | section | | | | | |
| | Thickness extension ratio A/a | — | 8.3 | 8.3 | 8.3 | 8.3 |
| | Temperature of die slit section | ° C. | 80 | 80 | 80 | 80 |
| Properties of | Thickness A of extruded foam | mm | 25 | 25 | 25 | 25 |
| extruded foam | Apparent density | kg/m³ | 35 | 35 | 35 | 35 |
| | Closed cell ratio | % | 95 | 95 | 96 | 95 |
| | Average cell diameter | mm | 0.1 | 0.1 | 0.1 | 0.1 |
| | Cell deformation ratio | — | 1.0 | 1.0 | 1.0 | 1.0 |

| | | | | | | |
|---|---|---|---|---|---|---|
| Residual amount of | just after production | mol | 0.063 | 0.063 | 0.063 | 0.063 |
| HFO-1234ze | after 100 days from | mol | 0.060 | 0.060 | 0.060 | 0.060 |
| | production | | | | | |

| | | | | | |
|---|---|---|---|---|---|
| Thermal conductivity after 100 days from | W/mK | 0.0266 | 0.0265 | 0.0267 | 0.0243 |
| production | | | | | |
| JIS combustibility | — | ◯ | ◯ | ◯ | ◯ |
| Appearance of foam | — | good | good | good | good |

TABLE 3

| | | | | Comparative | Comparative | Comparative |
|---|---|---|---|---|---|---|
| | | | | Example 1 | Example 2 | Example 3 |
| Component | Substrate resin | Styrene resin 1 | parts | 100 | 100 | 100 |
| | | Styrene resin 2 | parts | 0 | 0 | 0 |
| | Radiation inhibitor | Graphite | parts | 0 | 0 | 0 |
| | Flame retardant | Bromine-containing | parts | 3.0 | 3.0 | 3.0 |
| | | flame retardant 1 | | | | |
| | | Bromine-containing | parts | 0 | 0 | 0 |
| | | flame retardant 2 | | | | |
| | Flame retardant | Triphenyl phosphine | parts | 1.0 | 1.0 | 1.0 |
| | promoter | oxide | | | | |
| | | Poly-1,4-diisopropyl | parts | 0 | 0 | 0 |
| | | benzene | | | | |
| | Stabilizer | Stabilizer 1 | parts | 0.10 | 0.10 | 0.10 |
| | | Stabilizer 2 | parts | 0 | 0 | 0 |
| | | Stabilizer 3 | parts | 0 | 0 | 0 |
| | | Stabilizer 4 | parts | 0 | 0 | 0 |
| | | Stabilizer 5 | parts | 0 | 0 | 0 |
| | | Stabilizer 6 | parts | 0.20 | 0.20 | 0.20 |
| | Lubricant | Calcium stearate | parts | 0.10 | 0.10 | 0.10 |
| | Water-absorptive | Bentonite | parts | 0 | 0 | 0 |
| | medium | Silica | parts | 0 | 0 | 0 |
| | Foaming agent | HFO-1234ze | parts | 7.5 | 7.5 | 7.5 |
| | | | mol | 0.066 | 0.066 | 0.066 |
| | | Dimethyl ether | parts | 3.5 | 3.5 | 3.5 |
| | | | mol | 0.076 | 0.076 | 0.076 |
| | | Ethyl chloride | parts | 0 | 0 | 0 |
| | | | mol | 0 | 0 | 0 |
| | | Water | parts | 0 | 0 | 0 |
| | | Total amount of | mol | 0.142 | 0.142 | 0.142 |
| | | foaming agents | | | | |
| | | excluding water | | | | |
| Production | Foaming temperature | | ° C. | 128 | 129 | 128 |
| conditions | Foaming pressure | | MPa | 3.0 | 4.0 | 11.0 |
| | Opening a in thickness direction of die slit | | mm | 5.8 | 5.2 | 1.2 |
| | section | | | | | |
| | Thickness extension ratio A/a | | — | 4.3 | 4.8 | 20.8 |
| | Temperature of die slit section | | ° C. | 80 | 80 | 80 |
| Properties of extruded foam | Thickness A of extruded foam | | mm | 25 | 25 | 25 |
| | Apparent density | | kg/m³ | A large | 40 | 50 |
| | Closed cell ratio | | % | number of | 87 | 93 |
| | Average cell diameter | | mm | spots were | 0.1 | 0.05 |
| | Cell deformation ratio | | — | generated | 1.0 | 1.6 |
| | Residual amount of | just after production | mol | and molding | 0.046 | 0.063 |
| | HFO-1234ze | after 100 days from | mol | failure | 0.033 | 0.058 |
| | | production | | occurred, and | | |

| | | | | |
|---|---|---|---|---|
| Thermal conductivity after 100 days from | W/mK | thus the test | 0.0293 | 0.0302 |
| production | | piece was not | | |
| JIS combustibility | — | obtained. | ◯ | ◯ |
| Appearance of foam | — | | Inferior | Inferior |
| | | | spots | waves on surface |

From Table 2, it was found that in Examples 1 to 9, by adjusting the thickness extension ratio A/a to 18 or less and adjusting the foaming pressure to a range of 4.5 to 10.0 MPa, extruded polystyrene foams could be obtained which were lightweight and had the excellent long-term heat-insulating property because whose apparent density was low such as 35 kg/m³, closed cell ratio was high such as 95 to 96%, average void content was small such as 0.1 mm, cell deformation ratio was near to “1” such as from 0.9 to L2, residual amount of HFO-1234Ze was almost constantly maintained almost for a long time, and the thermal conductivity was low; which had the excellent flame retardance because the evaluation of the JIS combustibility thereof was “◯”; and which had the excellent appearance without spots or waves on the surface.

From Table 3, even if the thickness extension ratio A/a was adjusted to 18 or less, when the foaming pressure is less than 4.5 MPa, a number of spots were generated on the surface of the foam and the molding failure occurred, and consequently the extruded polystyrene foam could not obtained (Comparative Example 1), or though the lightness and the flame retardance were relatively good, the long-term heat-insulating property was insufficient, spots were generated on the surface, and the appearance was deteriorated (Comparative Example 2). When the thickness extension ratio A/a was more than 18 and the foaming pressure was more than 10 MPa, though the flame retardance was relatively good, the lightness and the heat-insulating property were reduced, and waves were generated on the surface and the appearance was deteriorated (Comparative Example 3).

1. A method for producing an extruded polystyrene foam the method comprising:
heat-melting a resin composition comprising a styrene resin;
adding a foaming agent to the heat-melted resin composition to obtain a foamable melted product; and
extruding and foaming the foamable melted product by extruding the foamable melted product into a low pressure zone through a die slit section of an extruder, the die slit section having an opening having a size of a mm in a thickness direction, to form a plate-shaped foam having a density of from 20 kg/m³ to 45 kg/m³, a closed cell ratio of 90% or more, and a thickness A of 10 mm or more and 150 mm or less,
wherein the foaming agent comprises hydrofluoroolefin and other organic foaming agent,
a thickness extension ratio A/a is 18 or less, and
the foamable melted product, just before the extrusion from the die slit section, is pressurized to 4.5 MPa to 10.0 MPa.

2. The method according to claim 1, wherein the thickness extension ratio A/a is from 3 to 18.

3. The method according to claim 1, wherein the opening of the die slit section has the size of a mm of from 1.0 mm to 15.0 mm.

4. The method according to claim 1, wherein the hydrofluoroolefin is added in an amount of from 0.030 mol to 0.125 mol, relative to 100 g of the styrene resin.

5. The method according to claim 1, wherein the hydrofluoroolefin is added in an amount of from 0.040 mol to 0.105 mol, relative to 100 g of the styrene resin.

6. The method according to claim 1, wherein the hydrofluoroolefin is tetrafluoropropene.

7. The method according to claim 1, wherein the other organic foaming agent comprises an organic foaming agent having a polystyrene permeability of 0.5×10⁻¹⁰ cc·cm/cm²·s·cm Hg or more, and does not comprise an organic foaming agent having a polystyrene permeability of less than 0.5×10⁻¹⁰ cc·cm/cm²·s·cm Hg.

8. The method according to claim 7, wherein the organic foaming agent having a polystyrene permeability of 0.5×10⁻¹⁰ cc·cm/cm²·s·cm Hg or more is at least one compound selected from the group consisting of dimethyl ether, methyl chloride, and ethyl chloride.

9. The method according to claim 1, wherein the hydrofluoroolefin and the other organic foaming agent are included in a total amount of from 0.105 mol to 0.300 mol, relative to 100 g of the styrene resin.

10. The method according to claim 1, wherein the resin composition further comprises a flame retardant in an amount of from 0.5 parts by weight to 8.0 parts by weight, relative to 100 parts by weight of the styrene resin.

11. The method according to claim 10, wherein the flame retardant is a bromine-containing flame retardant, and the bromine-containing flame retardant is included in an amount of from 0.5 parts by weight to 6.0 parts by weight, relative to 100 parts by weight of the styrene resin.

12. The method according to claim 1, wherein the resin composition further comprises a heat ray radiation inhibitor.

13. The method according to claim 12, wherein the heat ray radiation inhibitor is at least one compound selected from the group consisting of graphite, titanium oxide, and barium sulfate.

14. The method according to claim 2, wherein the opening of the die slit section has the size of a mm of from 1.0 mm to 15.0 mm.

15. The method according to claim 1, wherein the heat-melting of the resin composition and the adding of the foaming agent are performed in the extruder.

16. The method according to claim 1, wherein the heat-melting of the resin composition comprises heating the resin composition at a temperature of from 150° C. to 260° C.

17. The method according to claim 1, wherein, in the extruding and foaming of the foamable melted product, the die slit section of the extruder has a temperature of from 70° C. to 90° C.

18. The method according to claim 1, wherein the styrene resin comprises a polystyrene resin.
